(19) United States
(12) Patent Application Publication
(10) Pub. No.: US 2018/0158031 A1
(43) Pub. Date: Jun. 7, 2018

(54) GENERATING ITINERARIES FROM EVENTS AND TASKS

(71) Applicant: Microsoft Technology Licensing, LLC, Redmond, WA (US)

(72) Inventors: Kshitij Sethi, Bellevue, WA (US); David Grochocki, JR., Seattle, WA (US); Elizabeth P. Salowitz, Seattle, WA (US); Jeff West, Sammamish, WA (US); David S. Alles, Seattle, WA (US); Silvana P. Moncayo, Seattle, WA (US)

(21) Appl. No.: 15/369,554

(22) Filed: Dec. 5, 2016

(51) Int. Cl. G06Q 10/10; G06Q 10/06

(52) U.S. Cl. CPC G06Q 10/1097; G06Q 10/063114

(57) ABSTRACT

Events associated with a user are determined. The events may be activities that were provided by the user with start and end times such as appointments. Tasks associated with the user are determined. The tasks may be similar to events, but may not have start and end times. Monitored user behavior is used to estimate how long each task will take to complete. Events or tasks not associated with the user, but that may be of interest to the user, are determined. Location information about the events and tasks is received, and traffic and map information is used to estimate travel time between the locations. The tasks and the events are ranked using user interest data. An itinerary is generated using a subset of the ranked events and/or tasks that considers travel time between the locations as well as the ranking.

### BACKGROUND

Calendar applications have become invaluable tools for time management. Typically, users of calendar applications enter events into the calendar by specifying the date and time that each event is scheduled to occur. Later, a user may be presented with an itinerary for a date, or range of dates, by the calendar application that includes all the events that were scheduled on the date or dates associated with the itinerary.

While such calendar applications are useful, there are several drawbacks associated with calendar applications. One such drawback is that they rely on the user (or other users) to explicitly enter events into the calendar and cannot infer events based on user behavior.

Another drawback associated with calendar applications is unscheduled time. Often, most of the time in a calendar is unscheduled, and there exists no way to automatically determine other events or activities that could be scheduled for the user in the unscheduled time.

Yet another drawback associated with calendar applications is tasks. Currently, many users keep a list of tasks that they would like to complete (e.g., pick up milk, buy new pants, and paint door). However, because these tasks may not have known start and end times, they may not be added to the calendar by the user.

### SUMMARY

A request for an itinerary by a user is received. Events associated with the user are determined. The events may be activities that were provided by the user with well-defined start and end times such as appointments, meetings, etc. Tasks associated with the user are determined. The tasks may be similar to events, but may not have associated start and end times. Monitored user behavior, as well as monitored behavior of other users, is used to estimate how long each task will take to complete. Events or tasks that were not associated with the user, but that may be of interest to the user, are determined. Location information about each of the events and tasks is received, and traffic and map information is used to estimate how long it will take the user to travel between the locations associated with the tasks and events. The tasks and events are ranked based on user interest data. An itinerary is generated using a subset of the ranked events and/or tasks that takes into account travel time between the locations associated with the events and/or tasks as well as the ranking.

In an implementation, a system for automatically generating an itinerary for a user using tasks and events associated with the user, and based on user interest data, user behavior data, and hours of operation, is provided. The system includes at least one computing device and an itinerary engine. The itinerary engine may be adapted to: determine a plurality of events, each event comprising a location, a start time, and an end time; determine a plurality of tasks, each task comprising a location; receive user behavior data; predict a duration for each task of the plurality of tasks based on the received user behavior data; determine hours of operation for the locations associated with the events and the tasks; and generate an itinerary based on the predicted durations, the start time and end time associated with each event, and the hours of operation for the locations, wherein the itinerary includes a subset of the plurality of tasks and a subset of the plurality of events.

In an implementation, a system for automatically generating an itinerary for a user using tasks and events associated with the user, and based on user interest data, user behavior data, and hours of operation, is provided. The system may include at least one computing device and an itinerary engine. The itinerary engine may be adapted to: receive a request for an itinerary, wherein the request includes a time range; determine a plurality of events, each event comprising a location, a start time, and an end time, and wherein each start time and end time is within the time range of the request; determine a plurality of tasks, each task comprising a location and a duration; generate a score for each task of the plurality of tasks and each event of the plurality of events; receive hours of operation for the locations associated with the events and the tasks; generate an itinerary based on the duration associated with each task, the start time and end time associated with each event, the hours of operation for the locations, and the generated scores, wherein the itinerary includes a subset of the plurality of tasks and a subset of the plurality of events; and provide the itinerary in response to the request.

In an implementation, a method for automatically generating an itinerary for a user using tasks and events associated with the user, and based on user interest data, user behavior data, and hours of operation, is provided. The method may include: receiving a request for an itinerary by a computing device, wherein the request includes a time range; determining a plurality of events by the computing device, each event comprising a location, a start time, and an end time, and wherein each start time and end time is within the time range of the request; determining a plurality of tasks by the computing device, each task comprising a location; predicting a duration for each task of the plurality of tasks; determining hours of operation for the locations associated with the events and the tasks by the computing device; receiving traffic and map data by the computing device; generating an itinerary based on the duration associated with each task, the start time and end time associated with each event, the traffic and map data, and the hours of operation for the locations by the computing device, wherein the itinerary includes a subset of the plurality of tasks and a subset of the plurality of events; and providing the itinerary in response to the request by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for generating itineraries;

FIG. 2 is an illustration of an implementation of an exemplary itinerary engine;

FIG. 3 is an illustration of an example user interface for presenting itineraries;

FIG. 4 is an operational flow of an implementation of a method for generating an itinerary using events and tasks associated with a user;

FIG. 5 is an operational flow of an implementation of a method for generating an itinerary using events and tasks associated with a user;

FIG. 6 is an operational flow of an implementation of a method for selecting an alternative task for a provided itinerary;

FIG. 7 is an operational flow of an implementation of a method for predicting durations for tasks; and

FIG. 8 shows an exemplary computing environment in which example embodiments and aspects may be implemented.

### DETAILED DESCRIPTION

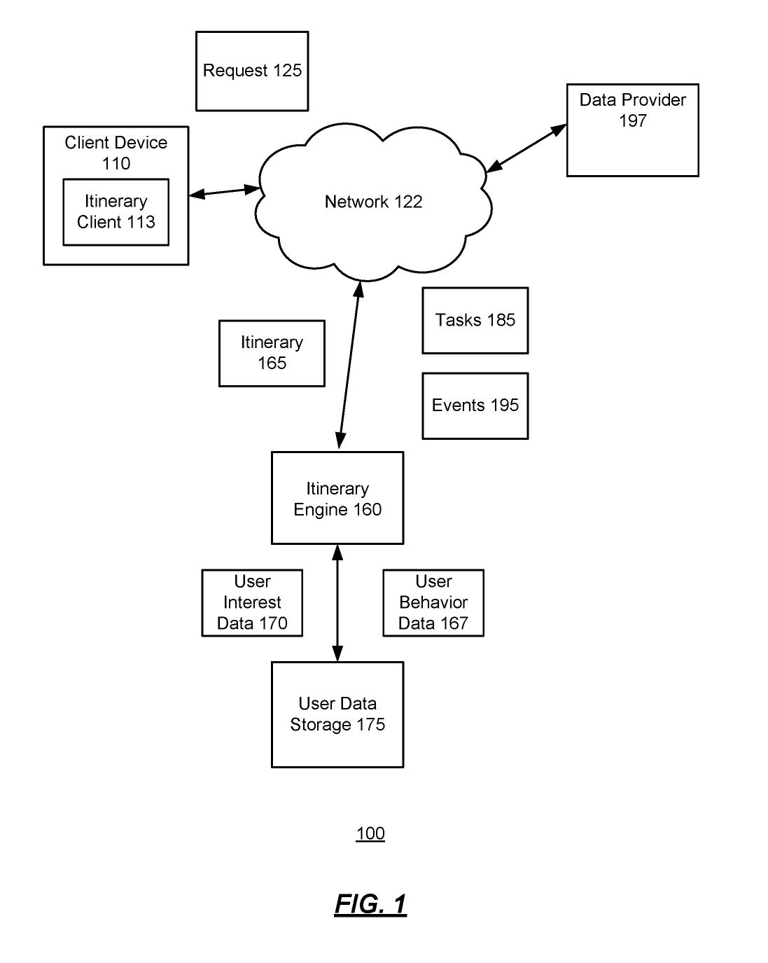

FIG. 1 is an illustration of an exemplary environment 100 for generating itineraries. The environment 100 may include an itinerary engine 160, a client device 110, and a data provider 197. Although only one client device 110, one itinerary engine 160, and one data provider 197 are shown in FIG. 1, there is no limit to the number of client devices 110, itinerary engines 160, and data providers 197 that may be supported.

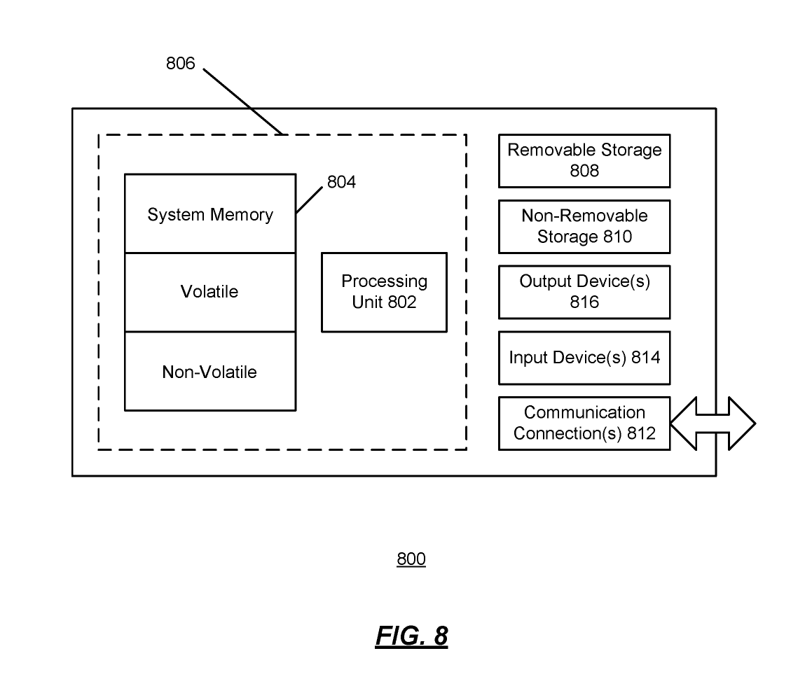

The client device 110, the itinerary engine 160, and the data provider 197 may be implemented using a variety of computing devices such as smartphones, desktop computers, laptop computers, tablets, and video game consoles. Other types of computing devices may be supported. A suitable computing device is illustrated in FIG. 8 as the computing device 800.

Each client device 110 may further include an itinerary client 113. The itinerary client 113 may receive requests 125 for an itinerary 165 from a user associated with the client device 110. The request 125 may include a date or range of dates and times that the user would like the itinerary 165 to cover. Depending on the implementation, the itinerary client 113 may be integrated into, or part of, a calendar application associated with the user. Other configurations may be supported.

The itinerary 165 may be an ordered sequence of events 195 and tasks 185, with each event 195 or task 185 associated with one or more timeslots of the itinerary 165. An event 195 may be an action or activity that the user may participate in. Each event 195 may have a well-defined start time and/or end time. Examples of events may include meetings, concerts, appointments, movies, plays, etc. Each event 195 may have a location where the event 195 takes place.

Tasks 185 may also include actions or activities that the user may participate it. Unlike events 195, each task 185 may not have a well-defined start time and/or end time. Tasks 185 may include actions or activities that the user would like to perform, but the user may be flexible about when the particular task 185 is performed or completed. Examples of tasks 185 could include running errands (e.g., pick up dry cleaning, go grocery shopping, fix window), performing discrete work projects (e.g., write letter, research report), and visiting people, places, or things (e.g., visit mother, go to carnival, visit tourist attraction). Like events 195, each task 185 may have a location where the task 185 takes place or will be completed.

As described further below, events 195 and tasks 185 may come from a variety of sources. Once source of events 195 and tasks 185 may be the user themselves. For example, a user may use the itinerary client 113 to create an event 195 for a meeting, or may use the itinerary client 113 to create a task 185 to visit a museum.

Another source of events 195 and tasks 185 may include applications. For example, many applications may generate events 195 or tasks 185 that the user may be invited to participate in. For example, social networking applications often invite users to attend a meeting (i.e., event 195) or ask the user to visit a business (i.e., task 185). Similarly, email applications and calendar applications often generate multiple events 195 and tasks 185.

Another source of events 195 and tasks 185 may include data providers 197. The events 195 and tasks 185 provided by the data providers 197 may be more general in nature, and more broadly applicable, than the events 195 and tasks 185 that are generated by the itinerary client 113 and/or applications. The information provided by the data providers 197 may include news, entertainment listings (e.g., movie and play times), restaurant booking information (i.e., available restaurant reservations), and any other information that may be used to identify events 195 and/or tasks 185 that are available in a particular region or location.

As described above, one problem associated with calendar applications is that they fail to automatically fill unused or unscheduled time. Accordingly, to solve the problem and other problems associated with calendar applications, the environment 100 may include the itinerary engine 160. The itinerary engine 160 may receive a request 125 for an itinerary 165 that includes a time range. In response to the request 125, the itinerary engine 160 may automatically generate an itinerary 165 for the time range specified in the request 125. The itinerary engine 160 may generate the itinerary using the tasks 185 and events 195 such that some or all of the available timeslots in the itinerary 165 are scheduled.

In some implementations, the itinerary engine 160 may select tasks 185 and events 195 using user interest data 170 collected from or about each user, and stored in the user data storage 175. The user interest data 170 may be one or more of provided by the user, or inferred based on user behavior data 167. The user behavior data 167 may be collected for each user by observing the types of events 195 and tasks 185 that the user participates in (or does not participate in), the types of media that the user enjoys (or does not enjoy), and how the user otherwise spends their time. Depending on the implementation, the user behavior data 167 may be collected by the itinerary client 113 using one or more sensors and/or applications running on the client device 110, for example. The user behavior data 167 may be stored by the itinerary engine 160 in the user data storage 175.

As may be appreciated, the user interest data 170 and/or the user behavior data 167 may be personal and private. Accordingly, to protect the privacy of the user, all of the user interest data 170 and/or user behavior data 167 may be encrypted. Moreover, before any data associated with a user is collected and/or used by the itinerary client 113 and/or the itinerary engine 160, the user may be asked to opt-in or otherwise consent to the use and/or collection of such data.

The itinerary engine 160 may rank the events 195 and tasks 185, and may select the events 195 and tasks 185 for the itinerary 165 based on the ranking. Depending on the implementation, each task 185 and event 195 may be associated with attributes that describe the task 185 or event 195. The attributes may be provided by the data providers 197, application, or itinerary client 113 that generated the tasks or events 195, or may be inferred by the itinerary engine 160 based on information such as text or a title that may be associated with the task 185 or event 195. The itinerary engine 160 may rank the tasks 185 and events 195 using the attributes and the user interest data 170. For example, the itinerary engine 160 may generate a score for each event 195 and task 185, and may rank the events 195 and the tasks 185 based on the scores.

The itinerary engine 160 may place the tasks 185 and the events 195 on the itinerary 165 according to the ranking. Initially, when generating the itinerary 165, the itinerary engine 160 may first place the events 195 on the itinerary 165 that were generated by the user of the client device 110, or that were otherwise accepted by the user of the client device 110. These events 195 may include events such as meetings, conference calls, appointments, etc.

After placing the user generated events 195 on the itinerary 165, the itinerary engine 160 may then select events 195 or tasks 185 for unassigned timeslots in the itinerary 165. In some implementations, the itinerary engine 160 may select events 195 or tasks 185 that result in the least amount of unscheduled time in the itinerary 165. Thus, in some instances, the itinerary engine 160 may select a lower ranked event 195 or task 185 when doing so will result in an itinerary 165 with less unscheduled time.

As described above, tasks 185 may not be associated with well-defined start times and/or end times. Accordingly, before a task 185 can be scheduled, the itinerary engine 160 may first estimate how long the particular task 185 will take to be completed. Depending on the implementation, the itinerary engine 160 may estimate the how long the task 185 will take using the user behavior data 167. For example, the itinerary engine 160 may determine from the user behavior data 167 how long the user previously took to complete the same or similar task 185. In addition, the itinerary engine 160 may consider how long other users took to complete the same or similar task 185 based on the user behavior data 167 associated with the other users.

The itinerary engine 160 may further consider the locations associated with each task 185 or event 195 when generating the itinerary 165. In one implementation, the locations associated with each task 185 or event 195 may be used to determine operating hours associated with the location, and the operating hours may be considered when selecting events 195 and tasks 185. For example, for a task 185 such as “pick up laundry at laundromat”, the itinerary engine 160 may determine the operating hours for the laundromat, and may only place the task 185 on the itinerary 165 in a timeslot when the laundromat is open.

The itinerary engine 160 may further consider the locations associated with tasks 185 and events 195 by incorporating travel time into the itinerary 165. For example, the itinerary engine 160 may estimate how long the user will take to travel between adjacent events 195 or tasks 185 on the itinerary 165 to ensure that the user has enough time to travel between the locations. The estimate may also consider historical traffic information associated with each location in the estimate.

The itinerary engine 160 may consider other information associated with each location such as the relative busyness of the location. For example, if its known that a location (such as a business) is busiest between 9 am and 10 am, then the itinerary engine 160 may add tasks 185 associated with the location to the itinerary 165 at times other than between 9 am and 10 am.

After generating the itinerary 165, the itinerary engine 160 may provide the generated itinerary 165 to the user at the client device 110. The user may then accept the itinerary 165, reject the itinerary 165, or reject particular events 195 and/or tasks 185 of the itinerary 165. If the user rejects the itinerary 165, the itinerary engine 160 may generate a new itinerary 165 as described above. If the user rejects one or more of the tasks 185 or events 195 of the itinerary 165, the itinerary engine 160 may select new events 195 or tasks 185 for the rejected one or more tasks 185 or events 195.

The itinerary engine 160 may be applicable to a variety of use cases. One such use case is for a user to plan their day. When a user wakes up, the itinerary engine 160 may present the user with an itinerary 165 for the day. As described above, the itinerary 165 may include all of the appointments and/or meetings (i.e., events 195) that the user scheduled for their day in their calendar, along with selected tasks 185 and events 195 placed in the unscheduled time. Because the locations of the tasks 185 and events 195 were considered, as well as traffic information, the user is assured that they will be able to reach all of the associated locations at the times specified in the itinerary 165.

Another use case is generating itineraries 165 for tourists. When a user is planning a trip to a city such as Rome, the user may have a rough idea of how they want to spend their time and what sites that they want to see. For example, a user may have signed up for one or more events 195 such as guided tours of the St. Peter's Basilica and the Sistine Chapel. The tours may be considered events 195 because they have start and end times. The user may have also indicated that they would like to visit the Spanish Steps, the Colosseum, and the Trevi Fountain. Because the user has not specified when the user would like to visit these attractions, visiting each attraction may be considered a task 185.

Before the user leaves for their trip, the user may generate a request 125 for an itinerary 165 for the trip. For example, if the trip is one week, the user may generate a request 125 for the entire week. In response, the itinerary engine 160 may generate an itinerary 165 for the trip that includes the events 195 such as the tours that the user signed up for. The itinerary 165 may further include the tasks 185 specified by the user (i.e., the Spanish Steps, the Colosseum, and the Trevi Fountain) with time durations that were determined by user behavior data 167 collected from other users on vacation in Rome.

In addition, the itinerary 165 may further include tasks 185 and events 195 received from data providers 197. These events 195 and the tasks 185 may include sites, attractions, restaurants, and other activities that are available while the user is in Rome. The events 195 and the tasks 185 may be ranked based on the user interest data 170 added to the itinerary 165 according to the ranking.

Moreover, as described above, the events 195 and the tasks 185 are placed into times of the itinerary 165 in a way that considers the locations associated with each event 195 and task 185, as well as the hours of operation associated with each location, and the historical traffic information. In this way, the tourist can be assured that they will be able to visit each location on their itinerary 165 without having any knowledge of the geography or traffic patterns of Rome.

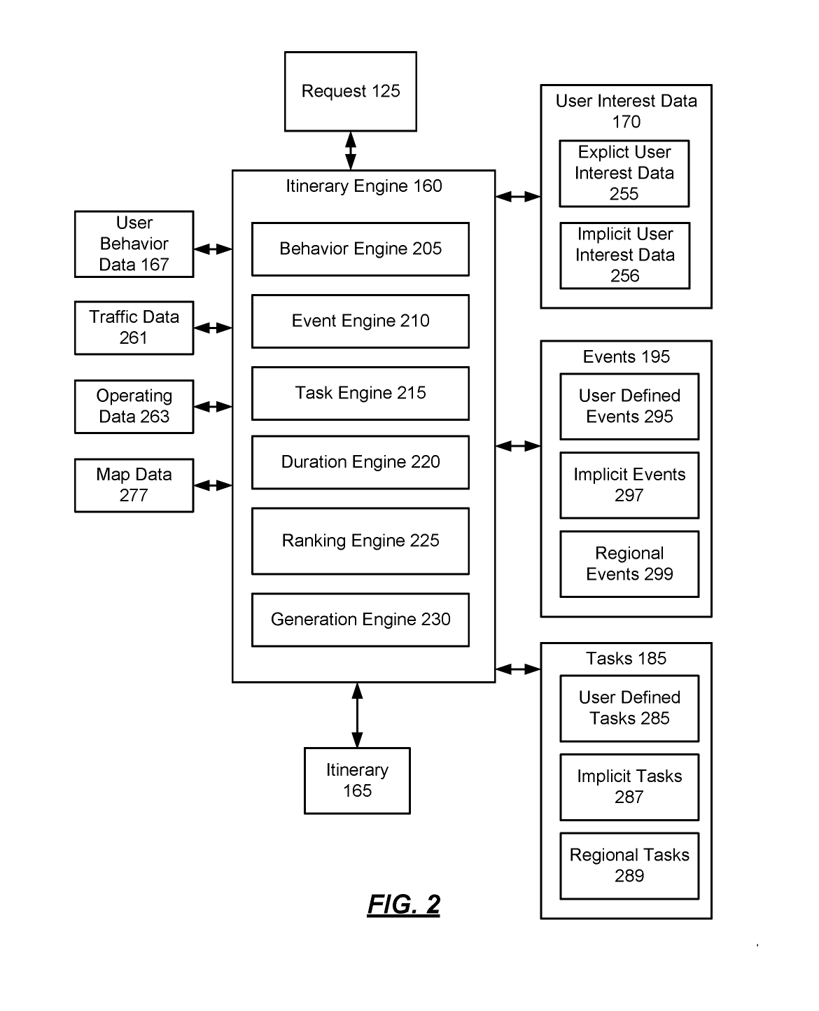

FIG. 2 is an illustration of an implementation of an exemplary itinerary engine 160. The itinerary engine 160 may include one or more components including a behavior engine 205, an event engine 210, a task engine 215, a duration engine 220, a ranking engine 225, and a generation engine 230. More or fewer components may be included in the itinerary engine 160. Some or all of the components of the itinerary engine 160 may be implemented by one or more computing devices such as the computing device 800 described with respect to FIG. 8.

The behavior engine 205 may generate user behavior data 167. In some implementations, the behavior engine 205 may generate user behavior data 167 for a user by monitoring the client device 110 associated with the user. The client device 110 may be monitored using a GPS or other sensor, or combination of sensors, to generate the user behavior data 167. The user behavior data 167 may indicate the various locations and businesses that the user visits and at what times, the routes that the user travels, and any other information that may be determined based on the user's location.

The behavior engine 205 may further generate user behavior data 167 by monitoring user interactions with one or more applications of the client device 110. For example, the behavior engine 205 may collect information such as the types of media that the user consumes, and what types of links the user tends to “click” or “like”. Other information may be included in the generated user behavior data 167. As noted above, the behavior engine 205 may only generate user behavior data 167 for a user after receiving the affirmative consent of the user.

The event engine 210 may determine events 195 for the user. As described above, the events 195 may include activities that have well-defined start times and/or end times. In some implementations, the events 195 may include user defined events 295, implicit events 297, and regional events 299. Other types of events 195 may be supported.

Each event 195 may be associated with a location. The location may be a specific location such as “home”, or “work”. When the event 195 can occur anywhere, such as a telephone call, the associated location may be “anywhere” or left unspecified.

The user defined events 295 may include those events 195 that were created by the user, or otherwise accepted by the user. The user defined events 295 may include meetings that the user scheduled or was invited to, conference calls that the user scheduled or was invited to, appointments, and any other activity that the user affirmatively indicated that they would like to attend. The user defined events 295 may be included in a calendar application associated with the user, for example. The location associated with each user defined event 295 may be determined by the event engine 210 based on information specified by the user, or may be determined based on context from a description associated with the user defined events 295. For example, a user defined event such as “department meeting” may be assumed to be located at the location where the user is employed.

The implicit events 297 may include events 195 that were not explicitly created by the user, but that may be determined based on the user behavior data 167. For example, the user behavior data 167 may indicate that the user takes a lunch break between 12:00 pm and 1:00 pm each day. Accordingly, the event engine 210 may determine an implicit event 297 of lunch that occurs between 12:00 pm and 1:00 pm. The event engine 210 may identify implicit events 297 by looking for patterns of user behavior in the user behavior data 167. The location associated with each implicit event 297 may be similarly determined from the user behavior data 167.

The regional events 299 may include events 195 that are not associated with the user, but are rather generally associated with, or are occurring in, a region or city where the user is located in, or will be located in, for the dates and times associated with the itinerary 165. The regional events 299 may include movies, plays, tours, parades, and any other type of activity that may be associated with a region. The regional events 299 may be determined by the event engine 210 from data provided by one or more data providers 197 such as newspapers, websites, or other data sources. The location associated with each regional event 299 may be provided by the associated data provider 197, for example.

The task engine 215 may determine tasks 185 for the user. As described above, the tasks 185 may include activities that do not have well-defined start times and/or end times. In some implementations, the tasks 185 may include user defined tasks 285, implicit tasks 287, and regional tasks 289. Other types of tasks 185 may be supported.

Each task 185 may be associated with a location. The location may be a specific location such as “home” or “work”. Where the task 185 can occur anywhere, such as a telephone call, the associated location may be “anywhere” or left unspecified.

The user defined tasks 285 may include those tasks 185 that were created by the user, or otherwise accepted by the user. For example, a user may provide user defined tasks 285 into a “to do list” or other task 185 tracking application. The location associated with each user defined task 285 may be determined by the task engine 215 based on information specified by the user, or may be determined based on context from a description associated with the user defined task 285. For example, a user defined task 285 such as “paint bedroom” may be assumed to be located at the user's home.

The implicit tasks 287 may include tasks 185 that were not explicitly created by the user, but that may be determined based on the user behavior data 167. For example, the user behavior data 167 may indicate that the user goes to the gym, but not at any particular time of the day. In another example, task engine 215 may determine from the user behavior data 167 that the user received an email or text message asking them to “pick up the dry cleaning” and may determine an implicit task 287 based on the message. The location associated with each implicit task 287 may be similarly determined from the user behavior data 167.

The regional tasks 289 may include tasks 185 that are not associated with the user, but are rather generally associated with or are occurring in a region or city where the user is located in, or will be located in. The regional tasks 289 may include attractions associated with the region (e.g., museums and parks), and activities that may be associated with the region (e.g., shopping, festivals, and outdoor activities). The regional tasks 289 may be determined by the task engine 215 from data provided by one or more data providers 197 such as newspapers, websites, or other data sources.

The duration engine 220 may determine a duration for a task 185. The duration for a task 185 may be an estimate of how long the task will take the user to complete. In some implementations, the duration engine 220 may determine the duration based on the user behavior data 167. For example, the duration engine 220 may use the user behavior data 167 to determine how long the user took to perform the task 185 (or a similar task) in the past, and may use the determined time as the duration for the task 185. Alternatively or additionally, the duration engine 220 may have a list or catalog of tasks 185, along with an estimated duration for each task 185. Depending on the implementation, the estimated duration for each task 185 may have been determined from the user behavior data 167 of other users that performed the task 185, for example.

The ranking engine 225 may rank the determined tasks 185 and events 195 based on user interest data 170. Depending on the implementation, the user interest data 170 may include explicit user interest data 255 and implicit user interest data 256. The explicit user interest data 255 may be user interest data 170 that was provided by the user. For example, a user may have completed a profile using the itinerary client 113 and provided information such as preferred activities (walking, biking, running, museums, art galleries, etc.), favorite types of movies, favorite music, and favorite types of food. The user may have further specified dislikes.

Depending on the implementation, the explicit user interest data may further be collected from user profiles associated with other applications. For example, a user may maintain a profile in one or more social networking applications. Other types of applications may be supported.

The implicit user interest data 256 may be determined by the ranking engine 225 using the user behavior data 167 collected by the behavior engine 205. The ranking engine 225 may determine the implicit user interest data 256 by looking for signals in the user behavior data 167 that may indicate what the user in interested. These signals may include what stores the user shops in, what restaurants the use eats in, and what types of activities the user takes part in. In some ways, the implicit user interest data 256 may be more accurate than the explicit user interest data 255 because the implicit user interest data 256 is determined based on observed user behavior, while the explicit user interest data 255 is based on how the user perceives themselves and may be more aspirational than representative. For example, when the user completed their profile, to appear more interesting and/or adventurous, the user may have listed their favorite food as Thai, and their interests as bicycling. However, based on the user behavior data 167 the user may eat mostly at fast food restaurants, and may never ride a bicycle.

The ranking engine 225 may rank the events 195 and the tasks 185 by assigning each task 185 and each event 195 a score. The score may represent the predicted affinity of the user to the task 185 or the event 195. In some implementations, the ranking engine 225 may generate the score using a model that takes the user interest data 170, and attributes associated with the events 195 and the tasks 185. Depending on the implementation, the attributes associated with the events 195 and the tasks 185 may have been created by the associated calendar application, or data provider 197. Alternatively, the attributes may have been created by the ranking engine 225 based on text, such as a title or other descriptive information, associated with the task 185 or the event 195.

The ranking engine 225 may include other signals when generating the score. For example, the ranking engine 225 may consider information such as reviews received for the event 195 or the task 185 (e.g., reviews from other users of the itinerary engine 160, and reviews from newspapers or other media sources). Other information such as how popular the event 195 or the task 185 is with other users of the itinerary engine 160 may be considered.

The generation engine 230 may generate an itinerary 165 for a user based on a request 125 and the tasks 185 and the events 195 that were determined for the user. Depending on the implementation, the request 125 may be generated by the itinerary client 113 and may include a time range. The request 125 may also include a location. For example, where the request 125 is request for an itinerary 165 to use on a trip to Mexico, the request 125 may specify where in Mexico the itinerary 165 will be used.

The request 125 may be provided by the itinerary client 113 on behalf of the user to the itinerary engine 160. For example, the user may enter a time range into the itinerary client 113, and the itinerary client 113 may provide a corresponding request 125 to the itinerary engine 160.

Alternatively or additionally, the request 125 may automatically be provided to the itinerary engine 160. For example, the itinerary client 113 may automatically generate a request 125 for an itinerary 165 in the morning. The itinerary client 113 may present the generated itinerary 165 to the user when they wake up or activate their client device 110.

The generation engine 230 may generate an itinerary 165 for a request 125 using the events 195 determined by the event engine 210 and the tasks 185 determined by the task engine 215. With respect to events 195, because each event 195 is associated with a well-defined start and end time, the generation engine 230 may only consider events 195 that are within the time range associated with the request 125.

In implementations where the request 125 is associated with a location, the generation engine 230 may only consider events 195 and tasks 185 that are associated the same location or region as the request 125. For example, where the request 125 is for an itinerary 165 that the user can complete in their current city, the generation engine 230 may only consider events 195 and tasks 185 that can be completed in the current city or are associated with a location that is the same, or close to, the current city.

The generation engine 230 may place some or all of the user defined events 295 under consideration on the itinerary 165 at the times and/or dates associated with the user defined events 295. As described above, the user defined events 295 are the events 195 that the users themselves provided or placed on their associated calendars. Accordingly, any generated itinerary 165 may include most or all of the user defined events 295.

The generation engine 230 may place determined tasks 185 and events 195 on the remaining timeslots of the itinerary 165 according to the scores generated by the ranking engine 225. For example, the generation engine 230 may rank the remaining events 195 and tasks 185 using the scores and may place the events 195 and the tasks 185 according to the ranking. In some implementations, the generation engine 230 may place the determined tasks 185 and events 195 on the itinerary 165 using the ranking, while also minimizing an amount of unscheduled time on the itinerary 165. Accordingly, a lower ranked task 185 or event 195 may be considered over a higher ranked task 185 or event 195 if placement of the lower ranked task 185 or event 195 results in less unscheduled time.

The generation engine 230 may further consider the hours of operation of the locations associated with each task 185 or event 195 when placing tasks 185 and events 195 on the schedule. The hours of operation for each location may indicate the times when the location Is open and therefore the associated task 185 or event 195 can be completed. The generation engine 230 may only place an event 195 or a task 185 on the itinerary at a timeslot when the associated location is indicated to open. The hours of operation for each location may be included in the operating data 263.

The generation engine 230 may further consider the overall busyness of the locations associated with each task 185 or each event 195 when placing tasks 185 and events 195 on the itinerary 165. The busyness of each location may indicate the times when a location is busy and times when the location is less busy. Because busy locations may be associated with long waits, the generation engine 230 may prefer to place events 195 and tasks 185 on the itinerary 165 at times when the associated locations are less busy. The busyness for each location may be included in the operating data 263.

The generation engine 230 may further consider travel times associated with locations when placing task 185 and events 195 on the itinerary 165. For example, the generation engine 230 may place tasks 185 and events 195 that are geographically close to one another at adjacent timeslots on the itinerary 165 to avoid unnecessary travel by the user. In addition, the generation engine 230 may ensure that enough time is built into the itinerary 165 to account for travel between the locations associated with adjacent events 195 and tasks 185. The travel times may be determined by the generation engine 230 using map data 277.

In addition to the map data 277, the generation engine 230 may also consider traffic data 261 when considering travel times. The traffic data 261 may include historical traffic data 261 at a variety of locations that may indicate what the traffic is like for the locations at different times. By considering traffic data 261, the generation engine 230 may generate more accurate travel time estimates, and where possible, may consider placing tasks 185 and events 195 at times when their locations are unlikely to be experiencing high traffic.

Depending on the implementation, the generation engine 230 may generate a single itinerary 165 for each request 125. Alternatively, the generation engine 230 generate multiple itineraries 165 for each request 125. The multiple itineraries 165 may be presented to the user by the itinerary client 113, and the user can select the itinerary 165 that they prefer.

In addition, in some implementations, for an itinerary 165, the user may be able to reject events 195 and/or tasks 185 that are placed on the itinerary 165. If the user rejects an event 195 or task 185 on the itinerary 165, the generation engine 230 may select a new task 185 or event 195 (or a combination of tasks 185 or events 195) to fill the timeslot previously occupied by the rejected event 195 or task 185 in the itinerary 165.

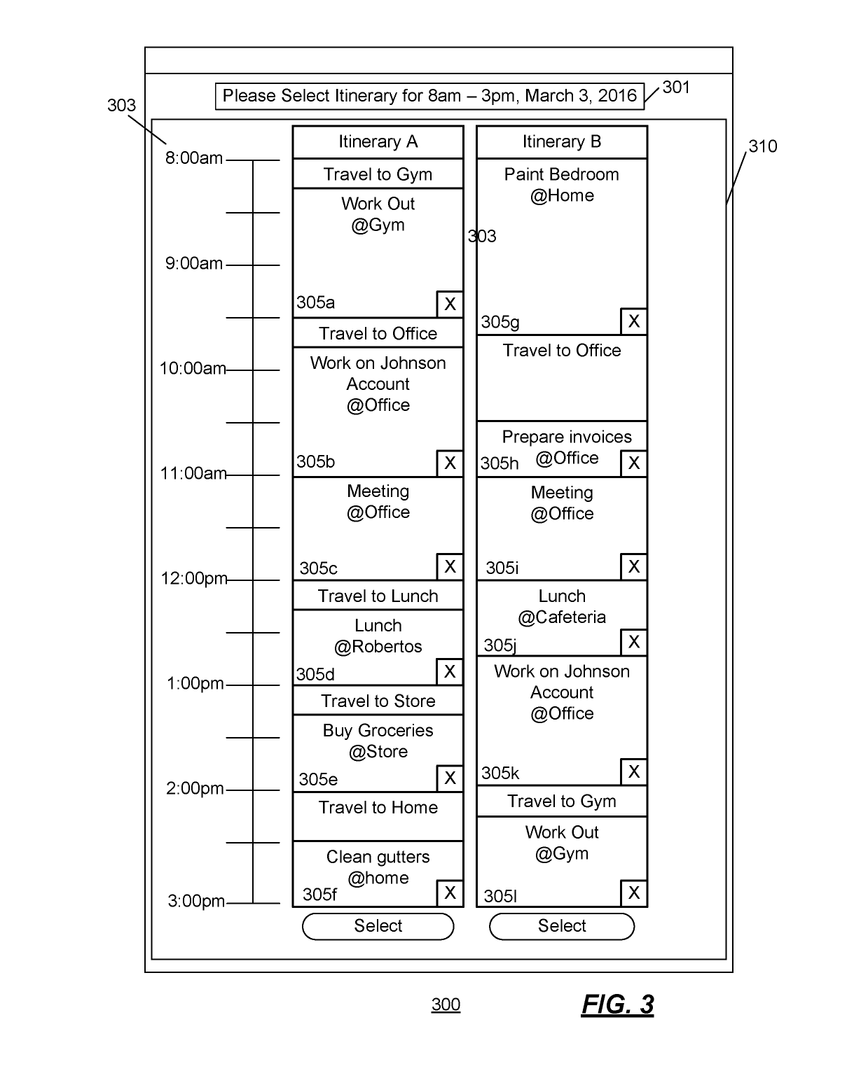

FIG. 3 is an illustration of an example user interface 300 for presenting itineraries 165. The user interface 300 includes a timeline 303 that includes timeslots corresponding to the itinerary 165. The user interface 300 also includes a window 310 where the itineraries 165 are presented to the user, and a window 301 that identifies the time range that is associated with the itineraries 165.

In the example shown, a user has requested an itinerary 165 for the time range corresponding to “8 am-3 pm, Mar. 3, 2016”. In response, the itinerary engine 160 has generated and displayed two suggested itineraries 165 in the window 310. The generated itineraries 165 are labeled “Itinerary A” and “Itinerary B.” Each itinerary 165 is displayed along with a user interface element labeled “Select” that the user can use to select the corresponding itinerary 165.

Each itinerary includes an entry 305 (i.e., the entries 305a-l) that corresponds to an event 195 or a task 185 associated with the user that submitted the request 125. Each entry 305 is aligned with the timeline 303 to indicate to the user the start time and end time associated with the task 185 or the event 195 associated with the entry.

Each event includes a description of the event and an indication of the location of the event. For example, the entry 305a is described as “work out” and is indicated to be located at the “Gym” by the use of the “@” symbol.

Depending on the implementation, the user may be able to receive more information about each entry 305 by selecting the entry in the window 310 using their finger, mouse, or another selection tool. The itinerary engine 160 may provide additional information such as type of event 195 or task 185 that the entry 305 represents, more details about the location, and information about why the event 195 or the task 185 was selected. Other information may be provided.

As shown, each entry 305 also includes a user interface element that the user can select to reject the task 185 or the event 195 associated with the entry 305. The user interface element is shown in each entry 305 as a box with an “x” in the lower right corner.

In addition, adjacent to some of the entries 305 are placeholders to account to for travel time between each location. For example, between the entry 305a and the entry 305b is the placeholder that represents time allotted to “Travel to Office”. There is no travel time between the entries 305b and 305c because those events are both associated with the location “Office.” Like the entries, the user can receive more information about the travel time, and how the travel time was calculated by selecting the associated placeholder.

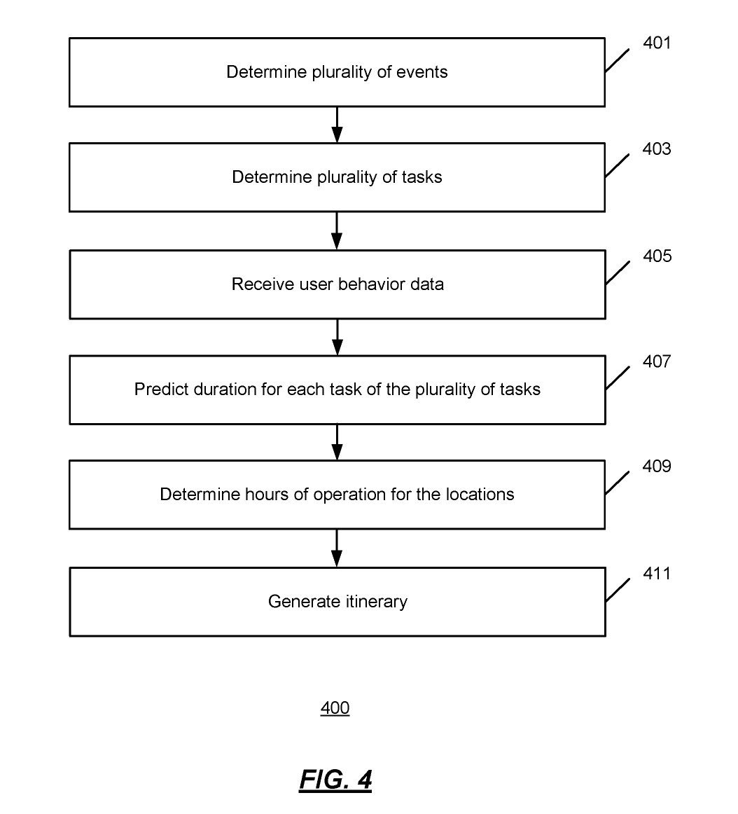

FIG. 4 is an operational flow of an implementation of a method 400 for generating an itinerary using events and tasks associated with a user. The method 400 may be implemented by the itinerary engine 160.

At 401, a plurality of events is determined. The plurality of events 195 may be determined by the event engine 210 of the itinerary engine 160. Each event 195 may be associated with a location where the event 195 will take place. Each event 195 may be associated with a start time and an end time. Depending on the implementation, the events 195 may be determined from a calendar application associated with a user, or may be determined from information provided by one or more data providers 197.

At 403, a plurality of tasks is determined. The plurality of tasks 185 may be determined by the task engine 215 of the itinerary engine 160. Each task 185 may be associated with a location where the task 185 will take place. Depending on the implementation, the tasks 185 may be determined from a to-do list application associated with the user, or may be determined from information provided by one or more data providers 197.

At 405, user behavior data is received. The user behavior data 167 may be received by the behavior engine 205 of the itinerary engine 160. The user behavior data 167 may include data that describes the habits and activities of the user. Depending on the implementation, the user behavior data 167 may be collected by monitoring the user using one or more sensors associated with the client device 110. The user behavior data 167 may include data about the user associated with the client device 110, or may include data about other users associated with the itinerary engine 160.

At 407, a duration is predicted for each task of the plurality of tasks. The duration for each task 185 may be predicted by the duration engine 220 of the itinerary engine 160. The duration for a task 185 may be the length of time that the task 185 is expected to complete. In some implementations, the duration may be predicted using the user behavior data 167. For example, the duration engine 220 may determine how long the user took to complete a particular task 185 in the past, and may predict the duration for the task 185 based on the determination. In some implementations, the duration engine 220 may also consider the user behavior data 167 associated with other users when predicting the duration for a task 185.

At 409, hours of operation are determined for the locations. The hours of operation may be determined by the generation engine 230 of the itinerary engine 160. The hours of operation for a location may describe the hours when the business or other concern associated with the location are open. As may be appreciated, an event 195 or a task 185 may not be completed at a location when the location is not open or otherwise available. The hours of operation may be determined from operating data 263 provided by one or more data providers 197.

At 411, an itinerary is generated. The itinerary 165 may be generated by the generation engine 230 of the itinerary engine 160. The itinerary 165 may be generated using the tasks 185, the events 195, the predicted durations, and the hours of operation. Depending on the implementation, the generation engine 230 may generate the itinerary 165 by selecting events 195 and/or tasks 185 for each timeslot of the itinerary 165 to minimize an amount of unscheduled time that remains in the itinerary 165. The tasks 185 may be selected based on the estimated durations and the hours of operation associated with the locations of the tasks 185. The events 195 may be selected based on the associated start times and ends times, and the hours of operation associated with the locations of the events 195.

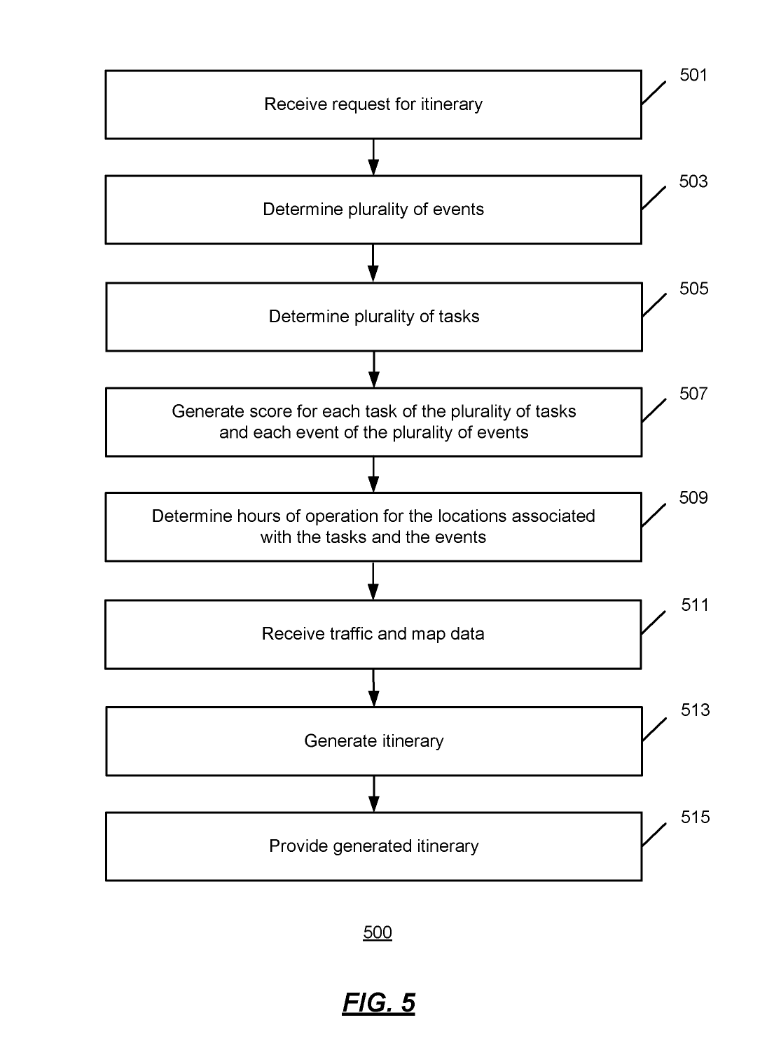

FIG. 5 is an operational flow of an implementation of a method 500 for generating an itinerary using events and tasks associated with a user. The method 500 may be implemented by the itinerary engine 160.

At 501, a request for an itinerary is received. The request 125 may be received by the itinerary engine 160. The request 125 may include a time range. The time range may specify a start date and time for the requested itinerary 165 and an end date and time for the requested itinerary 165. In addition, the request 125 may also include a location that indicates where the itinerary 165 will be used. For example, a user leaving for a vacation may use the itinerary client 113 to generate a request 125 for an itinerary 165 to use on vacation. The time range for the request 125 may be the dates and times associated with the vacation, and the location may be the location where the user will be going on vacation.

At 503, a plurality of events is determined. The plurality of events 195 may be determined by the event engine 210 of the itinerary engine 160. Each event 195 may be associated with a location where the event 195 will take place. Each event 195 may be associated with a start time and an end time. Depending on the implementation, the determined events 195 may be events 195 that have start times and end times that fall within the time range of the request 125.

At 505, a plurality of tasks is determined. The plurality of tasks 185 may be determined by the task engine 215 of the itinerary engine 160. Each task 185 may be associated with a location where the task 185 will take place, and may be associated with a duration that is an estimate of how long the task 185 will take to complete.

At 507, a score is generated for each task of the plurality of tasks and each event of the plurality of events. The score for each event 195 and each task 185 may be generated by the ranking engine 225. Depending on the implementation, the score may be an indication of how likely the user is to enjoy or approve of the associated task 185 or event 195. The score may be generated based on user interest data 170. The user interest data 170 may include explicit user interest data 255 (e.g., a profile created by the user), and implicit user interest data 256 that was generated by the behavior engine 205 from user behavior data 167 collected by the behavior engine 205.

At 509, hours of operation are determined for the locations. The hours of operation may be determined by the generation engine 230 of the itinerary engine 160. The hours of operation for a location may describe the hours when the business or other concern associated with the location is open. The hours of operation may be determined from operating data 263 provided by one or more data providers 197.

At 511, traffic and map data is received. The traffic and map data may be received by the generation engine 230. The traffic data 261 may include historical traffic data about each location associated with a determined event 195 or task 185. The map data 277 may include map information that may be used to generate routes and calculate distances between the locations associated with the events 195 and tasks 185. The map data 277 and traffic data 261 may be received from one or more data providers 197.

At 513, an itinerary is generated. The itinerary 165 may be generated by the generation engine 230 of the itinerary engine 160. The itinerary 165 may include a subset of the determined plurality of tasks and the determined plurality of events. The itinerary 165 may be generated using the tasks 185, the events 195, the scores, the hours of operation, the traffic data 261, and the map data 277. Depending on the implementation, the generation engine 230 may generate the itinerary 165 by selecting events 195 and/or tasks 185 for each timeslot of the itinerary 165 according to the associated scores. The generation engine 230 may further consider the hours of operation so that events 195 and tasks 185 are only placed in slots of the itinerary 165 at times when the associated locations are open. The generation engine 230 may further consider the traffic data 261 and map data 277 such that there is enough time for the user to travel from the locations associated with adjacent events 195 and/or tasks 185 in the itinerary 165.

At 515, the itinerary is provided. The itinerary 165 may be provided by the generation engine 230 of the itinerary engine 160. The itinerary 165 may be provided to the itinerary client 113 and may be displayed to the user that submitted the corresponding request 125.

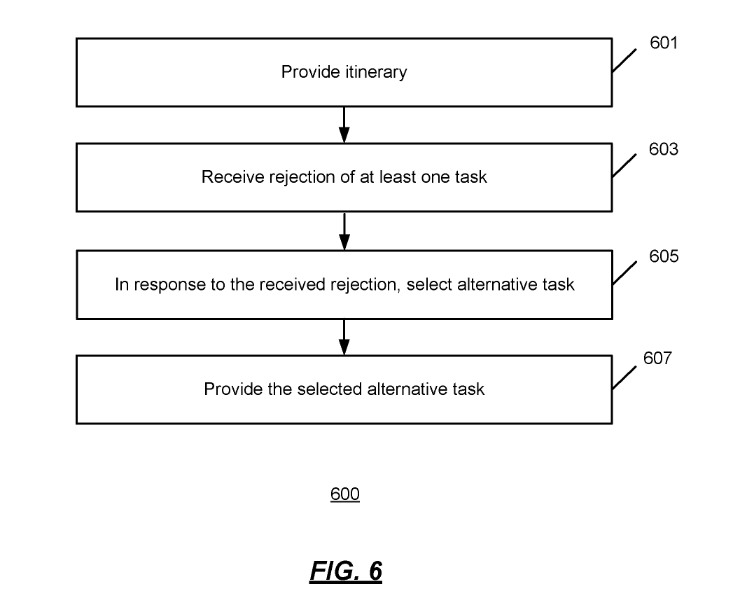

FIG. 6 is an operational flow of an implementation of a method 600 for selecting an alternative task for a provided itinerary. The method 600 may be implemented by the itinerary engine 160.

At 601, an itinerary is provided. The itinerary 165 may be provided by the itinerary engine 160. The itinerary 165 may have been generated in response to a request 125 from a user, and may be displayed to the user in a user interface associated with the itinerary client 113.

At 603, a rejection of at least one task is received. The rejection may be received by the generation engine 230 of the itinerary engine 160. The rejection may be received from the user that was provided the itinerary 165. The user may have viewed the displayed itinerary 165 and may have selected the at least one task 185 to reject using the user interface. The rejected task 185 may be associated with a timeslot of the itinerary 165.

At 605, an alternative task is selected in response to the received rejection. The alternative task may be selected by the generation engine 230 of the itinerary engine 160. The generation engine 230 may select the alternative task 185 by selecting a task 185 from the determined plurality of tasks 185 with a similar duration as the rejected task 185. In addition, the generation engine may select a task 185 having a similar location, and a similar score, for example.

At 607, the selected alternative task is provided. The alternative task may be provided by the generation engine 230 of the itinerary engine 160. The selected alternative task 185 may be provided to the itinerary client 113 and displayed to the user along with the original itinerary 165.

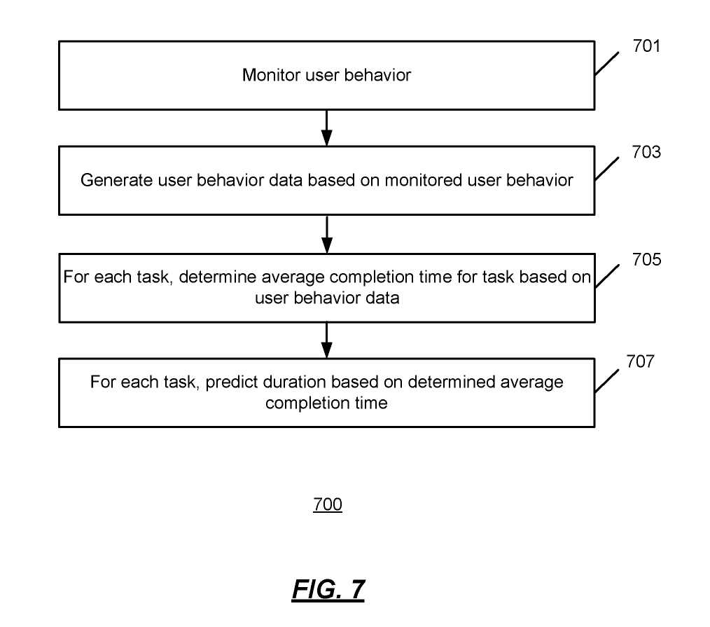

FIG. 7 is an operational flow of an implementation of a method 700 for predicting durations for tasks. The method 700 may be implemented by the itinerary engine 160.

At 701, user behavior is monitored. The user behavior may be monitored by the behavior engine 205 of the itinerary engine 160. The user behavior may be monitored using one or more sensors associated with the client device 110 such as a GPS, for example. The monitored behavior may indicate locations that the user travels to, how long the user spends at each location, tasks 185 and events 195 that the user participates, etc. Depending on the implementation, the itinerary client 113 may further monitor user interactions with other applications such as internet browsers, social networking applications, and communication applications.

At 703, user behavior data is generated based on the monitored user behavior. The user behavior data 167 may be generated by the behavior engine 205 of the itinerary engine 160.

At 705, an average completion time for each task is determined based on the user behavior data. The average completion times may be determined by the duration engine 220 of the itinerary engine 160 using the user behavior data 167. For example, for each task 185 the duration engine 220 may identify instances where the user performed the same or similar task 185 in the past, and may determine the average completion time for the task 185 based on the times associated with each instance of the task 185 or similar task 185. In other implementations, the duration engine 220 may determine the average durations by consulting a database or other data source that includes computed average completion times for a variety of tasks 185.

At 707, a duration is predicted for each task based on the determined average completion times. The average completion times may be determined by the duration engine 220 of the itinerary engine 160.

FIG. 8 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 800. In its most basic configuration, computing device 800 typically includes at least one processing unit 802 and memory 804. Depending on the exact configuration and type of computing device, memory 804 may be volatile (such as random access memory (RAM)), non-volatile (such as read-only memory (ROM), flash memory, etc.), or some combination of the two. This most basic configuration is illustrated in FIG. 8 by dashed line 806.

Computing device 800 may have additional features/functionality. For example, computing device 800 may include additional storage (removable and/or non-removable) including, but not limited to, magnetic or optical disks or tape. Such additional storage is illustrated in FIG. 8 by removable storage 808 and non-removable storage 810.

Computing device 800 typically includes a variety of computer readable media. Computer readable media can be any available media that can be accessed by the device 800 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 804, removable storage 808, and non-removable storage 810 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1000. Any such computer storage media may be part of computing device 800.

Computing device 800 may contain communication connection(s) 812 that allow the device to communicate with other devices. Computing device 800 may also have input device(s) 814 such as a keyboard, mouse, pen, voice input device, touch input device, etc. Output device(s) 816 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a system for automatically generating an itinerary for a user using tasks and events associated with the user, and based on user interest data, user behavior data, and hours of operation is provided. The system includes at least one computing device and an itinerary engine. The itinerary engine may be adapted to: determine a plurality of events, each event comprising a location, a start time, and an end time; determine a plurality of tasks, each task comprising a location; receive user behavior data; predict a duration for each task of the plurality of tasks based on the received user behavior data; determine hours of operation for the locations associated with the events and the tasks; and generate an itinerary based on the predicted durations, the start time and end time associated with each event, and the hours of operation for the locations, wherein the itinerary includes a subset of the plurality of tasks and a subset of the plurality of events.

Implementations may include some or all of the following features. The itinerary engine may be further adapted to generate at least one task of the plurality of tasks based on the received user behavior data. The itinerary engine may be further adapted to determine at least one event of the plurality of events from a calendar application. The itinerary engine may be further adapted to: monitor a user; and generate the user behavior data based on the monitoring. The itinerary engine may be further adapted to generate a score for each event of the plurality of events based on user interest data. The itinerary engine may be further adapted to generate the itinerary based on the predicted durations, the start time and end time associated with each event, the hours of operation for the locations, and the generated scores. The itinerary engine may be further adapted to generate the user interest data from the user behavior data. The itinerary engine adapted to predict the duration for each task of the plurality of tasks based on the received user behavior data may include the itinerary engine adapted to, for each task, determine an average completion time of the task using the user behavior data, and predict the duration for the task based on the average completion time. The itinerary engine may be further adapted to receive traffic and map data, and the itinerary engine may be further adapted to generate the itinerary based on the predicted durations, the start time and end time associated with each event, the hours of operation for the locations, and the received traffic and map data.

In an implementation, a system for automatically generating an itinerary for a user using tasks and events associated with the user, and based on user interest data, user behavior data, and hours of operation is provided. The system may include at least one computing device and an itinerary engine. The itinerary engine may be adapted to: receive a request for an itinerary, wherein the request includes a time range; determine a plurality of events, each event comprising a location, a start time, and an end time, and wherein each start time and end time is within the time range of the request; determine a plurality of tasks, each task comprising a location and a duration; generate a score for each task of the plurality of tasks and each event of the plurality of events; receive hours of operation for the locations associated with the events and the tasks; generate an itinerary based on the duration associated with each task, the start time and end time associated with each event, the hours of operation for the locations, and the generated scores, wherein the itinerary includes a subset of the plurality of tasks and a subset of the plurality of events; and provide the itinerary in response to the request.

Implementations may include some or all of the following features. The itinerary engine may be further adapted to receive user behavior data, and to predict the duration associated with at least one task of the plurality of tasks using the received user behavior data. The itinerary engine adapted to predict the duration associated with the at least one task may include the itinerary engine adapted to determine an average completion time of the at least one task using the user behavior data, and predict the duration for the at least one task based on the average completion time. The itinerary engine may be adapted to receive user interest data, and to generate the score for each task of the plurality of tasks and each event of the plurality of events using the user interest data. The itinerary engine may be further adapted to receive user behavior data, and to generate the user interest data from the user behavior data. The itinerary engine may be further adapted to receive traffic and map data, and the itinerary engine may be further adapted to generate the itinerary based on the duration associated with each task, the start time and end time associated with each event, the hours of operation for the locations, the generated scores, and the received traffic and map data. The itinerary engine may be further adapted to determine at least one event of the plurality of events from a calendar application.

In an implementation, a method for automatically generating an itinerary for a user using tasks and events associated with the user, and based on user interest data, user behavior data, and hours of operation is provided. The method may include: receiving a request for an itinerary by a computing device, wherein the request includes a time range; determining a plurality of events by the computing device, each event comprising a location, a start time, and an end time, and wherein each start time and end time is within the time range of the request; determining a plurality of tasks by the computing device, each task comprising a location; predicting a duration for each task of the plurality of tasks; determining hours of operation for the locations associated with the events and the tasks by the computing device; receiving traffic and map data by the computing device; generating an itinerary based on the duration associated with each task, the start time and end time associated with each event, the traffic and map data, and the hours of operation for the locations by the computing device, wherein the itinerary includes a subset of the plurality of tasks and a subset of the plurality of events; and providing the itinerary in response to the request by the computing device.

Implementations may include some or all of the following features. The method may further include: receiving a rejection of at least one task of the provided itinerary; in response to the received rejection, selecting an alternative task from the plurality of tasks; and providing the selected alternative task. The method may further include: receiving user behavior data; and predicting the duration associated with at least one task based on the received user behavior data. The method may further include determining at least one event of the plurality of events from a calendar application.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system for automatically generating an itinerary for a user using tasks and events associated with the user, and based on user interest data, user behavior data, and hours of operation, the system comprising:
at least one computing device; and
an itinerary engine adapted to:
determine a plurality of events, each event comprising a location, a start time, and an end time;
determine a plurality of tasks, each task comprising a location;
receive user behavior data;
predict a duration for each task of the plurality of tasks based on the received user behavior data;
determine hours of operation for the locations associated with the events and the tasks; and
generate an itinerary based on the predicted durations, the start time and end time associated with each event, and the hours of operation for the locations, wherein the itinerary includes a subset of the plurality of tasks and a subset of the plurality of events.

2. The system of claim 1, wherein the itinerary engine is further adapted to generate at least one task of the plurality of tasks based on the received user behavior data.

3. The system of claim 1, wherein the itinerary engine is further adapted to determine at least one event of the plurality of events from a calendar application.

4. The system of claim 1, wherein the itinerary engine is further adapted to:
monitor a user; and
generate the user behavior data based on the monitoring.

5. The system of claim 1, wherein the itinerary engine is further adapted to generate a score for each event of the plurality of events based on user interest data.

6. The system of claim 5, wherein the itinerary engine is further adapted to generate the itinerary based on the predicted durations, the start time and end time associated with each event, the hours of operation for the locations, and the generated scores.

7. The system of claim 5, wherein the itinerary engine is further adapted to generate the user interest data from the user behavior data.

8. The system of claim 1, wherein the itinerary engine adapted to predict the duration for each task of the plurality of tasks based on the received user behavior data comprises the itinerary engine adapted to, for each task, determine an average completion time of the task using the user behavior data, and predict the duration for the task based on the average completion time.

9. The system of claim 1, wherein the itinerary engine is further adapted to receive traffic and map data, and the itinerary engine is further adapted to generate the itinerary based on the predicted durations, the start time and end time associated with each event, the hours of operation for the locations, and the received traffic and map data.

10. A system for automatically generating an itinerary for a user using tasks and events associated with the user, and based on user interest data, user behavior data, and hours of operation, the system comprising:
at least one computing device; and
an itinerary engine adapted to:
receive a request for an itinerary, wherein the request includes a time range;
determine a plurality of events, each event comprising a location, a start time, and an end time, and wherein each start time and end time is within the time range of the request;
determine a plurality of tasks, each task comprising a location and a duration;
generate a score for each task of the plurality of tasks and each event of the plurality of events;
receive hours of operation for the locations associated with the events and the tasks;
generate an itinerary based on the duration associated with each task, the start time and end time associated with each event, the hours of operation for the locations, and the generated scores, wherein the itinerary includes a subset of the plurality of tasks and a subset of the plurality of events; and
provide the itinerary in response to the request.

11. The system of claim 10, wherein the itinerary engine is further adapted to receive user behavior data, and to predict the duration associated with at least one task of the plurality of tasks using the received user behavior data.

12. The system of claim 11, wherein the itinerary engine adapted to predict the duration associated with the at least one task comprises the itinerary engine adapted to determine an average completion time of the at least one task using the user behavior data, and predict the duration for the at least one task based on the average completion time.

13. The system of claim 10, wherein the itinerary engine is adapted to receive user interest data, and to generate the score for each task of the plurality of tasks and each event of the plurality of events using the user interest data.

14. The system of claim 13, wherein the itinerary engine is further adapted to receive user behavior data, and to generate the user interest data from the user behavior data.

15. The system of claim 10, wherein the itinerary engine is further adapted to receive traffic and map data, and the itinerary engine is further adapted to generate the itinerary based on the duration associated with each task, the start time and end time associated with each event, the hours of operation for the locations, the generated scores, and the received traffic and map data.

16. The system of claim 10, wherein the itinerary engine is further adapted to determine at least one event of the plurality of events from a calendar application.

17. A method for automatically generating an itinerary for a user using tasks and events associated with the user, and based on user interest data, user behavior data, and hours of operation, the method comprising:
receiving a request for an itinerary by a computing device, wherein the request includes a time range;
determining a plurality of events by the computing device, each event comprising a location, a start time, and an end time, and wherein each start time and end time is within the time range of the request;
determining a plurality of tasks by the computing device, each task comprising a location;
predicting a duration for each task of the plurality of tasks by the computing device;
determining hours of operation for the locations associated with the events and the tasks by the computing device;
receiving traffic and map data by the computing device;
generating an itinerary based on the duration associated with each task, the start time and end time associated with each event, the traffic and map data, and the hours of operation for the locations by the computing device, wherein the itinerary includes a subset of the plurality of tasks and a subset of the plurality of events; and
providing the itinerary in response to the request by the computing device.

18. The method of claim 17, further comprising:
receiving a rejection of at least one task of the provided itinerary;
in response to the received rejection, selecting an alternative task from the plurality of tasks; and
providing the selected alternative task.

19. The method of claim 17, further comprising
receiving user behavior data; and
predicting the duration associated with at least one task based on the received user behavior data.

20. The method of claim 17, further comprising determine at least one event of the plurality of events from a calendar application.
